(19) United States
(12) Patent Application Publication
(10) Pub. No.: US 2020/0226550 A1
(43) Pub. Date: Jul. 16, 2020

(54) METHOD TO DETERMINE OPTIMAL MEETING LOCATION AND TIME

(71) Applicant: Carrier Corporation, Palm Beach Gardens, FL (US)

(72) Inventors: Jason Higley, Pittsford, NY (US); Wilmann Gomez, New Britain, CT (US); Dang Nguyen, Alpharetta, GA (US); Ben Holm, Farmington, NY (US); Yuri Novozhenets, Pittsford, NY (US); Maxim Rydkin, Penfield, NY (US)

(21) Appl. No.: 16/630,986

(22) PCT Filed: Jul. 11, 2018
(86) PCT No.: PCT/US2018/041611

§ 371 Date: Jan. 14, 2020

Related U.S. Application Data
(60) Provisional application No. 62/532,495, filed on Jul. 14, 2017.

(51) Int. Cl. G06Q 10/10; G06Q 10/02; G06Q 10/06; G06F 16/2457

(52) U.S. Cl. CPC G06Q 10/1095; G06Q 10/02; G01C 21/00; G06Q 10/06312; G06F 16/24578; G06Q 10/06314

(57) ABSTRACT

A method of scheduling a meeting room is provided. The method comprising: receiving an attendee list including one or more attendees; obtaining an attendee detail for each attendee in response to the attendee list; determining a weighted ranking for each attendee in response to the attendee detail; obtaining an attendee schedule for each attendee; determining one or more optimal meeting times in response to the attendee schedule; determining a position for each attendee prior to each of the optimal meeting times; determining an optimal meeting location for each optimal meeting time in response to the weighted ranking for each attendee and the position for each attendee; obtaining a meeting room schedule for one or more meeting rooms located within a selected distance of the optimal meeting location at each optimal meeting time; and reserving one of the meeting rooms.

### BACKGROUND

The subject matter disclosed herein generally relates to the field of scheduling systems, and more particularly to an apparatus and method for determining optimal meeting times and locations.

Existing scheduling systems allow users to view attendees' schedules but often do little further to help determine when and where to schedule a meeting. With attendee time at a premium determining optimum meeting times and locations is desired.

### BRIEF SUMMARY

According to one embodiment, a method of scheduling a meeting room is provided. The method comprising: receiving an attendee list including one or more attendees; obtaining an attendee detail for each attendee in response to the attendee list; determining a weighted ranking for each attendee in response to the attendee detail; obtaining an attendee schedule for each attendee; determining one or more optimal meeting times in response to the attendee schedule; determining a position for each attendee prior to each of the optimal meeting times; determining an optimal meeting location for each optimal meeting time in response to the weighted ranking for each attendee and the position for each attendee; obtaining a meeting room schedule for one or more meeting rooms located within a selected distance of the optimal meeting location at each optimal meeting time; and reserving one of the meeting rooms.

In addition to one or more of the features described above, or as an alternative, further embodiments may include where the determining a position for each attendee prior to each of the optimal meeting times further comprises: determining a current position of each attendee when the optimal meeting time is now.

In addition to one or more of the features described above, or as an alternative, further embodiments may include where the current position is determined by detecting a current position of each attendee.

In addition to one or more of the features described above, or as an alternative, further embodiments may include where the current position is determined by checking each attendee schedule and mapping a position in response to the attendee schedule.

In addition to one or more of the features described above, or as an alternative, further embodiments may include where the determining a position for each attendee prior to each of the optimal meeting times further comprises: determining a future position of each attendee when the optimal meeting time is in the future; and the future position is determined by checking each attendee schedule and mapping a position in response to the attendee schedule.

In addition to one or more of the features described above, or as an alternative, further embodiments may include where the determining a position for each attendee prior to each of the optimal meeting times further comprises: assigning a home position to the position of an attendee when the optimal meeting time is now and a current location of the attendee cannot be determined or when the optimal meeting is in the future and a future position of the attendee cannot be determined.

In addition to one or more of the features described above, or as an alternative, further embodiments may include where prior to the obtaining a meeting room schedule for one or more meeting rooms located within a selected distance of the optimal meeting location at each optimal meeting time, the method further comprises: obtaining a path for each individual from each position to each optimal meeting location; and adjusting the optimal meeting location in response to at least one path.

In addition to one or more of the features described above, or as an alternative, further embodiments may include adjusting a meeting resource when a mobile device is presented.

According to another embodiment, a scheduling system is provided. A scheduling system comprising: a processor; a memory comprising computer-executable instructions that, when executed by the processor, cause the processor to perform operations, the operations comprising: receiving an attendee list including one or more attendees; obtaining an attendee detail for each attendee in response to the attendee list; determining a weighted ranking for each attendee in response to the attendee detail; obtaining an attendee schedule for each attendee; determining one or more optimal meeting times in response to the attendee schedule; determining a position for each attendee prior to each of the optimal meeting times; determining an optimal meeting location for each optimal meeting time in response to the weighted ranking for each attendee and the position for each attendee; obtaining a meeting room schedule for one or more meeting rooms located within a selected distance of the optimal meeting location at each optimal meeting time; and reserving one of the meeting rooms.

In addition to one or more of the features described above, or as an alternative, further embodiments may include where the determining a position for each attendee prior to each of the optimal meeting times further comprises: determining a current position of each attendee when the optimal meeting time is now.

In addition to one or more of the features described above, or as an alternative, further embodiments may include where the current position is determined by detecting a current position of each attendee.

In addition to one or more of the features described above, or as an alternative, further embodiments may include where the current position is determined by checking each attendee schedule and mapping a position in response to the attendee schedule.

In addition to one or more of the features described above, or as an alternative, further embodiments may include where the determining a position for each attendee prior to each of the optimal meeting times further comprises: determining a future position of each attendee when the optimal meeting time is in the future; and the future position is determined by checking each attendee schedule and mapping a position in response to the attendee schedule.

In addition to one or more of the features described above, or as an alternative, further embodiments may include where the determining a position for each attendee prior to each of the optimal meeting times further comprises: assigning a home position to the position of an attendee when the optimal meeting time is now and a current location of the attendee cannot be determined or when the optimal meeting is in the future and a future position of the attendee cannot be determined.

In addition to one or more of the features described above, or as an alternative, further embodiments may include where prior to the obtaining a meeting room schedule for one or more meeting rooms located within a selected distance of the optimal meeting location at each optimal meeting time, the operations further comprise: obtaining a path for each individual from each position to each optimal meeting location; and adjusting the optimal meeting location in response to at least one path.

In addition to one or more of the features described above, or as an alternative, further embodiments may include where the operations further comprise adjusting a meeting resource when a mobile device is presented.

According to another embodiment, a computer program product tangibly embodied on a computer readable medium, the computer program product including instructions that, when executed by a processor, cause the processor to perform operations comprising: receiving an attendee list including one or more attendees; obtaining an attendee detail for each attendee in response to the attendee list; determining a weighted ranking for each attendee in response to the attendee detail; obtaining an attendee schedule for each attendee; determining one or more optimal meeting times in response to the attendee schedule; determining a position for each attendee prior to each of the optimal meeting times; determining an optimal meeting location for each optimal meeting time in response to the weighted ranking for each attendee and the position for each attendee; obtaining a meeting room schedule for one or more meeting rooms located within a selected distance of the optimal meeting location at each optimal meeting time; and reserving one of the meeting rooms.

In addition to one or more of the features described above, or as an alternative, further embodiments may include where the determining a position for each attendee prior to each of the optimal meeting times further comprises: determining a current position of each attendee when the optimal meeting time is now.

In addition to one or more of the features described above, or as an alternative, further embodiments may include where the current position is determined by detecting a current position of each attendee.

In addition to one or more of the features described above, or as an alternative, further embodiments may include where the current position is determined by checking each attendee schedule and mapping a position in response to the attendee schedule.

Technical effects of embodiments of the present disclosure include determining an optimal time and optimal location for a meeting in response to the location of each attendee, weighted rank of each attendee and schedule of each attendee.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

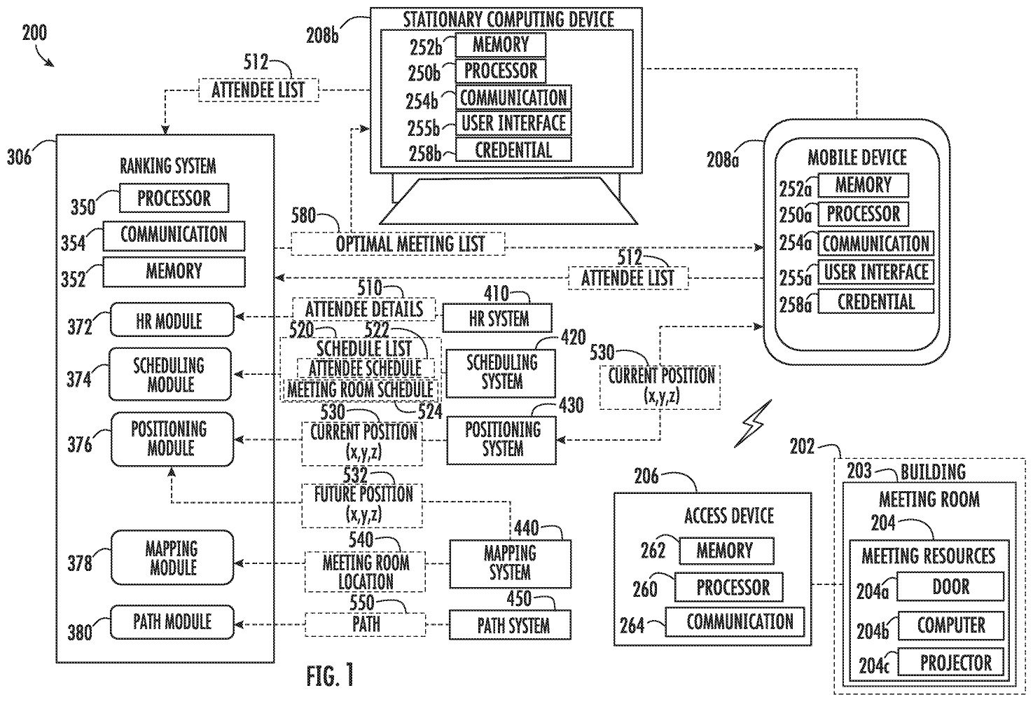

FIG. 1 illustrates a schematic view of a scheduling system, in accordance with an embodiment of the disclosure; and

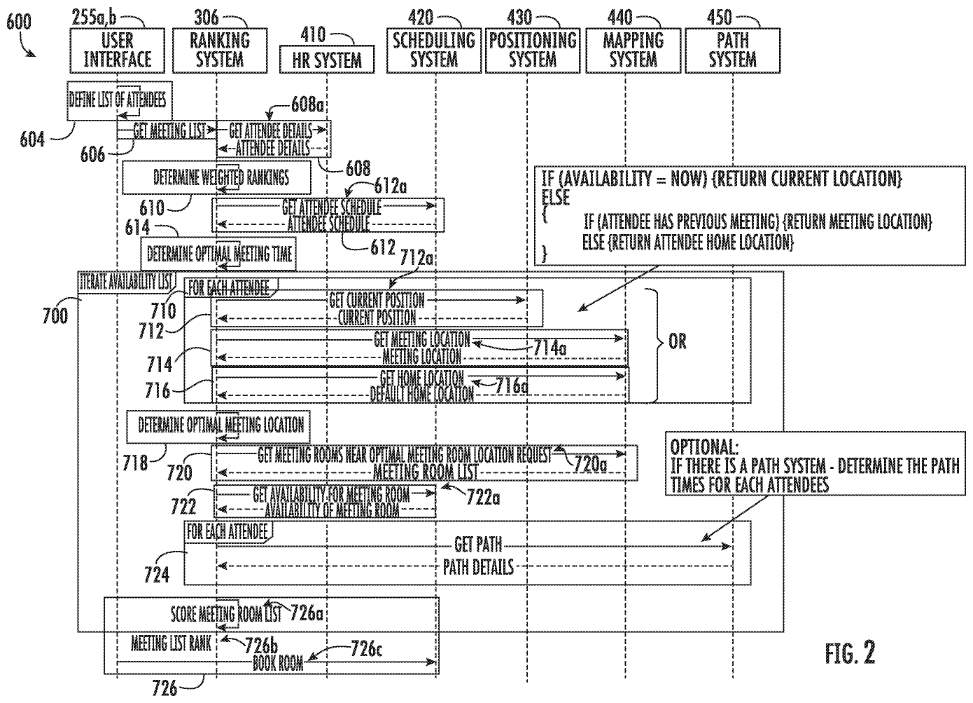

FIG. 2 is a flow diagram illustrating a method of scheduling a meeting room, according to an embodiment of the present disclosure.

### DETAILED DESCRIPTION

A detailed description of one or more embodiments of the disclosed apparatus and method are presented herein by way of exemplification and not limitation with reference to the Figures.

FIG. 1 depicts a scheduling system 200 in an example embodiment. The scheduling system 200 includes a ranking system 306. The ranking system 306 is configured to determine an optimal meeting list 580 in response to an attendee list 512 input by a meeting host. The optimal meeting list 580 may include one or more optimal meeting rooms for an optimal meeting time and optimal meeting location. The optimal meeting room may be a meeting room 203 within a building 202. In some embodiments, the building 202 may be a building or a collection of buildings that may or may not be physically located near each other. The building 202 may include any number of floors. Persons entering the building 202 may enter at a lobby floor, or any other floor, and may go to a destination floor via one or more conveyance devices, such as an elevator or escalator.

In two non-limiting embodiments, the attendee list 512 may be transmitted to the ranking system 306 from a mobile device 208a and/or a stationary computing device 208b. The mobile device 208a and the stationary computing device 208b may be in electronic communication with each other.

The mobile device 208a is capable of secure bi-directional communication with the stationary computing device 208b, the ranking system 306, and an access device 206 discussed later. The mobile device 208a may be a mobile computing device that is typically carried by a person, such as, for example a phone, PDA, smart watch, tablet, laptop, etc. The mobile device 208a may include a processor 250a, memory 252a and communication module 254a as shown in FIG. 1. The processor 250a can be any type or combination of computer processors, such as a microprocessor, microcontroller, digital signal processor, application specific integrated circuit, programmable logic device, and/or field programmable gate array. The memory 252a is an example of a non-transitory computer readable storage medium tangibly embodied in the mobile device 208a including executable instructions stored therein, for instance, as firmware. The communication module 254a may implement one or more communication protocols as described in further detail herein. The mobile device 208a is configured to store a unique credential 258a that may be shared with the stationary computing device 208b, access device 206, and ranking system 306. In a non-limiting example, the mobile device 208a may belong to an employee and/or resident of the building 202. The mobile device 208a may also include an application. Embodiments disclosed herein, may operate through the application installed on the mobile device 208a.

The stationary computing device 208b is capable of secure bi-directional communication with the mobile device 208a and the ranking system 306. The stationary computing device 208b may be a computing device not regularly transported, such as, for example a computer desktop, etc. The stationary computing device 208b may include a processor 250b, memory 252b, and communication module 254b as shown in FIG. 1. The processor 250b can be any type or combination of computer processors, such as a microprocessor, microcontroller, digital signal processor, application specific integrated circuit, programmable logic device, and/or field programmable gate array. The memory 252b is an example of a non-transitory computer readable storage medium tangibly embodied in the mobile device 208b including executable instructions stored therein, for instance, as firmware. The communication module 254b may implement one or more communication protocols as described in further detail herein. The stationary computing device 208b is configured to store a unique credential 258b that may be shared with the mobile device 208a, access device 206, and ranking system 306. In a non-limiting example, the stationary computing device 208b may belong to an employee and/or resident of the building 202. The stationary computing device 208b may also include an application. Embodiments disclosed herein, may operate through the application installed on the stationary computing device 208b. A stationary computing device 208b may be linked to a mobile device 208a. For example, an employee of a company may have a stationary computing device 208b and a mobile device 208a. The credentials 258a, 258b may help identify the mobile device 208a and the stationary computing device 208b so that they may be synced with each other.

Also shown in FIG. 1 is the ranking system 306. The ranking system 306 is configured to determine optimal meeting list 580 for in response to the attendee list 512. The ranking system 306 may include a processor 350, memory 352, and communication module 354 as shown in FIG. 1. The processor 350 can be any type or combination of computer processors, such as a microprocessor, microcontroller, digital signal processor, application specific integrated circuit, programmable logic device, and/or field programmable gate array. The memory 352 is an example of a non-transitory computer readable storage medium tangibly embodied in or operably connected to the path determination system including executable instructions stored therein, for instance, as firmware. The communication module 354 may implement one or more communication protocols as described in further detail herein.

The ranking system 306 also includes: a human resources (HR) module 372 in communication with an HR system 410; a scheduling module 374 in communication with a scheduling system 420; a positioning module 376 in communication with a positioning system 430; and a mapping module 378 in communication with a mapping system 440. The ranking system 306 may also include a path module 380 in communication with a path system 450, discussed further below. In the illustration of FIG. 1, the HR system 410, the scheduling system 420, the positioning system 430, the mapping system 440, and the path system 450 are illustrated as separate systems external to the ranking system 306 and communicate with their respective modules (i.e. HR module 372, scheduling module 374, positioning module 376, mapping module 378, and path module 380). In an embodiment, at least one of the HR system 410, the scheduling system 420, the positioning system 430, the mapping system 440, and the path system 450 is included within the ranking system 306. In another embodiment, at least one of the HR system 410, the scheduling system 420, the positioning system 430, the mapping system 440, and the path system 450 in the mobile device 208a. In yet another embodiment, at least one of the HR system 410, the scheduling system 420, the positioning system 430, the mapping system 440, and the path system 450 is included within the stationary computing device 208b.

The HR system 410 includes attendee details 510 including but not limited to a rank/position within a business for each attendee on the attendee list. For instance, the attendee details 510 may list an employee as a CEO, Vice President, Manager, Associate . . . etc. in a few non-limiting example. The attendee details 510 may be an organization chart. Each rank/position in the attendee details 510 may be given a weighted ranking in accordance with an organizational chart within the company. The higher the weighted ranking the more important the rank/position of the attendee. For instance, a CEO may be given more weight than a manager. The ranking system 306 generates an attendee weighted ranking for each attendee on the attendee list 512 in response to the attendee detail list 510. Advantageously, the ranking system 306 may use the weighted rankings to ensure that higher ranking attendees do not need to travel far to meetings.

The scheduling system 420 manages the schedules lists 520 including attendee schedules 522 and meeting room schedules 524. The attendee schedules 522 are the calendar schedule of each attendee on the attendee list 512 including but not limited to meetings, events, and reminders. The meeting room schedules 524 are the calendar schedule of each meeting room 203. In an example, the scheduling system 420 may include electronic calendars such as, Microsoft Outlook Calendars, Gmail Calendars, iCloud Calendar, and Android Calendars. The scheduling system 420 is configured to transmit a schedule list 520 to the ranking system 306 when requested, as discussed further below.

The positioning system 430 is configured to determine the current position 530 of each attendee on the attendee list 512 in an (x, y, z) coordinate system through tracking the mobile device 208a of each attendee. The current position 530 may also be tracked using other methods including but not limited to RFID tags, facial recognition systems, laptop trackers, detecting a location based on the access device 206 requests, or any known positional determination method known to one of skill in the art. The positioning system 430 may use various methods in order to determine the location of each mobile device 208a such as, for example, GPS, Bluetooth triangulation, Wi-Fi triangulation, cellular signal triangulation, or any other location determination method known to one of skill in the art. The (x, y, z) coordinates may translate to a latitude, a longitude, and an elevation. The positioning system 430 is configured to transmit the current position 530 to the ranking system 306, which will be discussed further below.

The mapping system 440 is configured to determine a meeting room location 540 of each meeting room 203 in an (x, y, z) coordinate system. The (x, y, z) coordinates may translate to a latitude, a longitude, and an elevation. The mapping system is configured to transmit the meeting room location 540 to the ranking system 306. The mapping system 440 is also configured to determine one or one or more future positions 532 for each attendee on the attendee list 512 in response to an attendee list 522. For example, an attendee list 522 may state that the CEO will be in the Main Conference Room at 5:00 pm tomorrow, thus the mapping system 440 determines that the CEO will have a future location 532 equivalent to that of the Main Conference room at 5:00 pm tomorrow. The mapping system 440 is configured to transmit the future position 532 to the ranking system 306. The mapping system 440 may also be configured to determine a location of various other building systems in an (x, y, z) coordinate system. The building systems may include but are not limited to access devices 206, lighting control, thermostat controls, elevators, doors, stairwells, desks, computers . . . etc.

The path system 450 is configured to determine a path 550 for each attendee on the attendee list 512. The path 550 may include how long it would take an individual attendee to travel from their current position 530 to each optimal meeting room on the optimal meeting list 580. The path 550 may also include how long it would take an individual attendee to travel from their future position 532 to each optimal meeting room on the optimal meeting list 580. The path system 450 may determine the path 550 based upon the shortest walking distance between each meeting room 203 and at least one of the current position 530 and the future position 532. The path system 450 may account for time spent on conveyance devices, such as, for example, elevators, escalators, and moving walkways. The path system 450 may also track and store historical path information for each individual attendee, which may be used to determine the path that the individual attendee would most likely take to each optimal meeting room on the optimal meeting list 580. Thus, the path system 450 may determine the path 550 in response to the historical path information between each meeting room 203 and at least one of the current position 530 and the future position 532. The path system 450 is configured to transmit a path 550 to the ranking system 306.

The ranking system 306 is configured to determine an optimal meeting list 580 in response to at least one of the attendee weighted rankings, the schedule lists 520, the current positions 530, the future positions 532, and the meeting room locations 540. The ranking system 306 displays the list of optimal meetings 580 on the mobile device 208a and/or the stationary computing device 208b. The optimal meeting list 580 includes an optimal meeting locations that is a geographically central location at an available time for a majority of attendees on the attendee list 512 if the attendees have the same attendee weighted ranking. However, the optimal meeting may not be a geographical central location and may be closest to an attendee with the highest attendee weighted ranking. Further, the “majority of attendees” may also be a weighted majority giving more weight to an available time of an attendee with the highest weighted ranking. The ranking system 306 may also factor into the path 550 in order to further help optimize the optimal meeting location. Thus, the optimal meeting occurs at the optimum location between all attendees on the attendee list 512 based upon how long it may take each attendee to travel along their own path to the meeting room 203. The user/meeting organizer may select an optimal meeting to book the meeting room 203.

Each meeting room 203 may include meeting resources 204 such as, for example a door 204a to the meeting room 203, a computer 204b, and/or a projector 204c. The meeting resources 204 may be operably connected to one or more access devices 206. The access device 206 may be configured to control access to the meeting resources 204 and may grant/deny access to meeting resources 204 within a meeting room 203. The access device 206 grant/deny access to the meeting resource 204 by adjusting the access point 203, such as, for example, unlocking a door lock on the door 204a, turning on the computer 204b, and turning on a projector 204c. It is understood that while only one meeting room 203 is shown in the building 202, the building 202 may contain more than one meetings rooms 203. It is also understood that each meeting room 203 may contain more than one of each meeting resource 204.

In a non-limiting example, the access device 206 may be a door reader, door strike, or electrical power control device. The access device 206 may include a processor 260, memory 262 and communication module 264 as shown in FIG. 1. The processor 260 can be any type or combination of computer processors, such as a microprocessor, microcontroller, digital signal processor, application specific integrated circuit, programmable logic device, and/or field programmable gate array. The memory 262 is an example of a non-transitory computer readable storage medium tangibly embodied in the access device 206 including executable instructions stored therein, for instance, as firmware. The memory 262 may store a unique device ID for each access device 206. The memory 262 may also store a set of geo-location information for each access device 206. The communication module 264 allows for secure bi-directional communication wirelessly with a mobile device 208a. The communication module 264 may implement one or more communication protocols as described in further detail herein. Once the meeting is booked, each attendee on the attendee list 512 may have the ability to utilize their mobile device 208a to adjust a meeting resource 204 through the access device 206. For example, each attendee may be able to access the door 204a, turn on the computer 204b, and/or turn on the projector 204c by presenting their mobile device 208a to an access device 206 coupled to the specific meeting resource 204.

The mobile device 208a communicates with the access device 206, stationary computing device 208b, and the ranking system 306. The stationary computing device 208b communicates with the mobile device 208a and the ranking system 306. The communication may be wired or may occur over a wireless network, such as 802.11x (Wi-Fi), short-range radio (Bluetooth), cellular, satellite, etc. In some embodiments, the ranking system 306 may include, or be associated with (e.g., communicatively coupled to) a networked element, such as kiosk, beacon, lantern, bridge, router, network node, building intercom system, etc. The networked element may communicate with the mobile device 208a using one or more communication protocols or standards. For example, the networked element may communicate with the mobile device 208a using near field communications (NFC). In an embodiment, the mobile device 208a may communicated with an access device 206 through a networked element. In other embodiments, the mobile device 208a may establish communication with a ranking system 306 or an access device 206 that is not associated with a networked element in the building 202. This connection may be established with various technologies including GPS, 802.11x (Wi-Fi), cellular, or satellite, by way of non-limiting example. In example embodiments, the mobile device 208a communicates over multiple independent wired and/or wireless networks. Embodiments are intended to cover a wide variety of types of communication and embodiments are not limited to the examples provided in this disclosure.

Referring now to FIG. 2, while referencing components of FIG. 1. FIG. 2 shows a flow chart of method 600 of a method of scheduling a meeting room 203, in accordance with an embodiment of the disclosure. At block 604, an attendee list 512 is defined by a meeting host through a user interface 255a, 255b. The attendee list 512 includes one or more attendees that the meeting host would like to attend a meeting. The attendee list 512 may be defined on either a mobile device 208a or a stationary computing device 208b, as described above. At block 606, the attendee list 512 is transmitted to and received by the ranking system 306. At block 608, the ranking system 306 obtains attendee details 510 for each attendee in response to the attendee list 512. As mentioned above, the attendee details 510 may depict the rank/position of an attendee within an organization (i.e. business, company, corporation, LLC, LLP . . . etc). In order to obtain the attendee detail 510 from the HR system 410, the ranking system 306 may transmit a get attendee detail request at 608a. At block 610, weighted rankings for each attendee are determined in response to the attendee details 510. In an embodiment, the ranking system 306 is configured to determine the weighted rankings.

At block 612, an attendee schedule 522 for each attendee is obtained. In order to obtain the attendee schedule 522 from the scheduling system 420, the ranking system 306 may transmit a get attendee schedule request at 612a. At block 614, one or more optimal meeting times are determined in response to the attendee schedules 522. In an embodiment, the ranking system 306 determines the one or more optimal meeting times. The one or more optimal meeting times may be ranked from best to worst based on how many attendees are available. The ranking may be weighed based on the weighted ranking of each attendee. For instance, if it is important to have a CEO at a meeting than the availability of the CEO will take priority over the availability of other lower weighted positions in terms of ranking the one or more optimal meeting times.

At block 700, the solutions may be iterated until one or more optimal meeting locations and optimal meeting times are determined. At block 710, a position for each attendee prior to each of the optimal meeting times is determined. Advantageously, the position for each attendee prior to each of the optimal meeting times is determined in order to calculate how far each attendee may be from each other, then aggregate a center point that is weighted by the weighted ranking in order to find a conference room located near the aggregated center point (optimal meeting location). The position may be a current position 530 or a future position 532 depending upon when the optimal meeting time may be. For example, if the optimal meeting time is now then the position may be a current position 530 for each attendee but if the optimal meeting time is in the future then the position may be a future position 532 for each attendee.

The position may be determined by any one of three methods as shown by blocks 712, 714, and 716. At block 712, the current position 530 is determined by detecting a current position of a mobile device 208a of each attendee using the positioning system 430, as described above. In order to obtain the current position 530, the ranking system 306 may transmit a get current position request 712a to the positioning system 430. At block 714, the current position 530 or the future position 532 may be determined by checking each attendee schedule 522 and mapping a position in response to the attendee schedule 522. For example, an attendee schedule will show what meeting room 203 the attendee may be in at any given time, thus the mapping system 440 will just need to map the location of the room in order to obtain the position of the attendee. In order to obtain the current position 530 or future position 532, the ranking system 306 may transmit a get meeting location request 714a to the mapping system 440. At block 716, if a current location 530 of the attendee cannot be determined when the optimal meeting time is now or a future position 532 of the attendee cannot be determined when the optimal meeting is in the future then a home position is assigned to the position of an attendee. The home position may be a desk and/or office belonging to the attendee. In order to obtain the home positions, the ranking system 306 may transmit a get home position request 716a to the mapping system 440.

At block 718, an optimal meeting location is determined for each optimal meeting time in response to the weighted ranking for each attendee and the position for each attendee. The optimal meeting location an aggregate position of the positions of each attendee at the optimal meeting time. For example, if two attendees were 100 ft. (3048 cm) away from each other, the optimal meeting location would be in the middle, about 50 ft. (1524 cm) away from each attendee. Further, if one attendee had a higher weighted ranking than the optimal meeting location would be shifted towards the one attendee with the higher weighted ranking.

At block 720, the mapping system 440 determines one or more meeting rooms 203 that are located within a selected distance of the optimal meeting location for each optimal meeting time. In order to obtain the meeting room locations 540, the ranking system 306 may transmit a get meeting rooms near optimal meeting location request 720a to the mapping system 440. At block 722, obtaining a meeting room schedule 524 for one or more meeting rooms 203 located within a selected distance of the optimal meeting location at each optimal meeting time is obtained. In order to obtain the meeting room schedules 524, the ranking system 306 may transmit a get availability for meeting room request 722a to the scheduling system 440.

Block 724 displays an optional step in method 600. The optimal meeting location for each optimal meeting time may further be adjusted by obtaining a path 550 for each individual's position to each optimal meeting location and adjusting the optimal meeting location in response to at least one path 550. The path 550 is the actual route a meeting attendee may take through at building 202 to the meeting room 203, as discussed above. In order to obtain the paths 550, the ranking system 306 may transmit a get path request 724a to the path system 450.

At block 726, one of the meeting rooms is reserved. As shown in FIG. 2, in order to reserve the meeting room 203, the ranking system 306 may first score the optimal meeting room list 580 based on time and location in two non-limiting examples. The optimal meeting room list 580 includes an optimal meeting room for each optimal meeting time and optimal meeting location. The optimal meeting list 580 may be sorted by the score and transmitted to at least one of the mobile device 208a and the stationary computing device 208b to be displayed at block 726b. Through the user interface 255a, 255b the meeting host may select one of the optimal meeting rooms in order to book (reserve) the room 726. The method 700 may further include, adjusting a meeting resource 240 when a mobile device 208a is presented. For example, unlocking a door 204a, turning on a computer 204b, and turning on a projector 204c when a mobile device 208a is presented. The mobile device 208a may be presented by entering the meeting room 203 and/or motioning towards the meeting resource 204 with the mobile device 208a, such as for example a tap towards the meeting resource 204 or on a portion of the meeting resource 204.

While the above description has described the flow process of FIG. 2 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of scheduling a meeting room, the method comprising:
receiving an attendee list including one or more attendees;
obtaining an attendee detail for each attendee in response to the attendee list;
determining a weighted ranking for each attendee in response to the attendee detail;
obtaining an attendee schedule for each attendee;
determining one or more optimal meeting times in response to the attendee schedule;
determining a position for each attendee prior to each of the optimal meeting times;
determining an optimal meeting location for each optimal meeting time in response to the weighted ranking for each attendee and the position for each attendee;
obtaining a meeting room schedule for one or more meeting rooms located within a selected distance of the optimal meeting location at each optimal meeting time; and
reserving one of the meeting rooms.

2. The method of claim 1, wherein the determining a position for each attendee prior to each of the optimal meeting times further comprises:
determining a current position of each attendee when the optimal meeting time is now.

3. The method of claim 2, wherein:
the current position is determined by detecting a current position of each attendee.

4. The method of claim 2, wherein:
the current position is determined by checking each attendee schedule and mapping a position in response to the attendee schedule.

5. The method of claim 1, wherein the determining a position for each attendee prior to each of the optimal meeting times further comprises:
determining a future position of each attendee when the optimal meeting time is in the future; and
the future position is determined by checking each attendee schedule and mapping a position in response to the attendee schedule.

6. The method of claim 1, wherein the determining a position for each attendee prior to each of the optimal meeting times further comprises:
assigning a home position to the position of an attendee when the optimal meeting time is now and a current location of the attendee cannot be determined or when the optimal meeting is in the future and a future position of the attendee cannot be determined.

7. The method of claim 1, wherein prior to the obtaining a meeting room schedule for one or more meeting rooms located within a selected distance of the optimal meeting location at each optimal meeting time, the method further comprises:
obtaining a path for each individual from each position to each optimal meeting location; and
adjusting the optimal meeting location in response to at least one path.

8. The method of claim 1, further comprising:
adjusting a meeting resource when a mobile device is presented.

9. A scheduling system comprising:
a processor;
a memory comprising computer-executable instructions that, when executed by the processor, cause the processor to perform operations, the operations comprising:
receiving an attendee list including one or more attendees;
obtaining an attendee detail for each attendee in response to the attendee list;
determining a weighted ranking for each attendee in response to the attendee detail;
obtaining an attendee schedule for each attendee;
determining one or more optimal meeting times in response to the attendee schedule;
determining a position for each attendee prior to each of the optimal meeting times;
determining an optimal meeting location for each optimal meeting time in response to the weighted ranking for each attendee and the position for each attendee;
obtaining a meeting room schedule for one or more meeting rooms located within a selected distance of the optimal meeting location at each optimal meeting time; and
reserving one of the meeting rooms.

10. The scheduling system of claim 9, wherein the determining a position for each attendee prior to each of the optimal meeting times further comprises:
determining a current position of each attendee when the optimal meeting time is now.

11. The scheduling system of claim 10, wherein:
the current position is determined by detecting a current position of each attendee.

12. The scheduling system of claim 10, wherein:
the current position is determined by checking each attendee schedule and mapping a position in response to the attendee schedule.

13. The scheduling system of claim 9, wherein the determining a position for each attendee prior to each of the optimal meeting times further comprises:
determining a future position of each attendee when the optimal meeting time is in the future; and
the future position is determined by checking each attendee schedule and mapping a position in response to the attendee schedule.

14. The scheduling system of claim 9, wherein the determining a position for each attendee prior to each of the optimal meeting times further comprises:
assigning a home position to the position of an attendee when the optimal meeting time is now and a current location of the attendee cannot be determined or when the optimal meeting is in the future and a future position of the attendee cannot be determined.

15. The scheduling system of claim 9, wherein prior to the obtaining a meeting room schedule for one or more meeting rooms located within a selected distance of the optimal meeting location at each optimal meeting time, the operations further comprise:
obtaining a path for each individual from each position to each optimal meeting location; and
adjusting the optimal meeting location in response to at least one path.

16. The scheduling system of claim 9, wherein the operations further comprise:
adjusting a meeting resource when a mobile device is presented.

17. A computer program product tangibly embodied on a computer readable medium, the computer program product including instructions that, when executed by a processor, cause the processor to perform operations comprising:
receiving an attendee list including one or more attendees;
obtaining an attendee detail for each attendee in response to the attendee list;
determining a weighted ranking for each attendee in response to the attendee detail;
obtaining an attendee schedule for each attendee;
determining one or more optimal meeting times in response to the attendee schedule;
determining a position for each attendee prior to each of the optimal meeting times;
determining an optimal meeting location for each optimal meeting time in response to the weighted ranking for each attendee and the position for each attendee;
obtaining a meeting room schedule for one or more meeting rooms located within a selected distance of the optimal meeting location at each optimal meeting time; and
reserving one of the meeting rooms.

18. The computer program product of claim 17, wherein the determining a position for each attendee prior to each of the optimal meeting times further comprises:
determining a current position of each attendee when the optimal meeting time is now.

19. The computer program product of claim 17, wherein:
the current position is determined by detecting a current position of each attendee.

20. The computer program product of claim 18, wherein:
the current position is determined by checking each attendee schedule and mapping a position in response to the attendee schedule.
